(19) United States
(12) Patent Application Publication
(10) Pub. No.: US 2023/0306154 A1
(43) Pub. Date: Sep. 28, 2023

(54) SYSTEMS AND METHODS FOR MODEL DRIVEN REAL-TIME SOLUTIONS FOR POWER SYSTEMS

(71) Applicant: OPERATION TECHNOLOGY, INC., Irvine, CA (US)

(72) Inventors: Tanuj Khandelwal, Irvine, CA (US); Mohammad Zadeh, Irvine, CA (US); Shaikh Sahid Hossain, Irvine, CA (US); Ahmed Saber, Irvine, CA (US)

(21) Appl. No.: 18/108,599

(22) Filed: Feb. 11, 2023

Related U.S. Application Data
(60) Provisional application No. 63/309,443, filed on Feb. 11, 2022.
(60) Provisional application No. 63/309,359, filed on Feb. 11, 2022.
(60) Provisional application No. 63/309,367, filed on Feb. 11, 2022.

(51) Int. Cl. G06F 30/20

(52) U.S. Cl. CPC G06F 30/20; G06F 2111/02

(57) ABSTRACT

Disclosed are example embodiments of a system for power system simulation, the system comprising: a processor; and a memory. The memory is coupled to the processor. The memory including instructions that, when executed by the processor cause the system to: generate dynamic graphical simulation of a power system, receive an input from the user of the power system simulation, generate a realistic response to the input from the user, and provide the response to the user.

### CLAIM OF PRIORITY UNDER 35 U.S.C. §119

The present Application for Patent claims priority to Provisional Application No. 63/309,443 entitled “SYSTEMS AND METHODS FOR MODEL DRIVEN REAL-TIME SOLUTIONS FOR POWER SYSTEMS” filed Feb. 11, 2022, Provisional Application No. 63/309,359, entitled “SYSTEMS AND METHODS FOR REMOTE MANAGEMENT OF ASSET AND DIGITAL PROTECTION RELAYS,” and Provisional Application No. 63/309,367, entitled “SYSTEMS AND METHODS FOR AI/ML BASED DIGITAL TWIN FOR POWER SYSTEM,” filed Feb. 11, 2022, each of which is assigned to the assignee hereof and each of which is hereby expressly incorporated by reference herein.

### TECHNICAL FIELD

The disclosure relates generally to the field of power systems, specifically and not by way of limitation, some embodiments are related to power system simulation.

### BACKGROUND OF THE INVENTION

Some of the industry challenges and operational issues may include, but are not limited to achieving a single source of truth for engineering and operation, mapping of electrical, physical, thermal characteristics for electrical equipment in transmission and distribution protection system, successful and continuous management of data and assets, a lack of centralized protection relay database information, manual process of relay settings upload and download, a lack of asset information repository, a tedious procedure for protection relay settings change management, different make and model of protection relays and their proprietary software, frequent incidences require root cause analysis to achieve system reliability and stability, a costly process of manual retrieval of disturbance records which requires special manpower to spend a full day, digital twin representation of the actual asset information, integration of asset management system with power system simulation to assist the power engineering to evaluate and optimizing the protection settings, time spent on data collection used for protection and arc flash studies, and/or relay performance under operating conditions and system disturbances.

Consequently, there is a need for systems and methods that may address the above discussed issues.

### SUMMARY

In one example implementation, an embodiment includes a systems and methods that may provide an environment that is effective for operator training and assistance. Operator training is accelerated using dynamic graphical simulation of the power system with realistic response to every action. This makes training an ongoing process. The ability to simulate the sequence-of-operation using real-time data is of fundamental importance to avoid inadvertent plant outages caused by human error, equipment overload, or other causes.

Disclosed are example embodiments of a system for power system simulation, the system comprising: a processor; and a memory. The memory is coupled to the processor. The memory including instructions that, when executed by the processor cause the system to: generate dynamic graphical simulation of a power system, receive an input from the user of the power system simulation, generate a realistic response to the input from the user, and provide the response to the user.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 is a block diagram illustrating a training simulator graphical user interface block in accordance with the systems and methods described herein.

FIG. 2 is a block diagram illustrating an example computing system in accordance with the systems and methods described herein.

FIG. 3 is a block diagram illustrating an example system architecture in accordance with the systems and methods described herein.

FIG. 4 is a block diagram illustrating data flow in accordance with the systems and methods described herein.

FIG. 5 is a block diagram illustrating example recordings of actions in accordance with the systems and methods described herein.

FIG. 6 is a block diagram illustrating example GUI I/O block for a scenario in accordance with the systems and methods described herein.

FIG. 7 is a block diagram illustrating example GUI I/O to initialize a console 700 in accordance with the systems and methods described herein.

FIG. 8 is a block diagram illustrating a training session review and audit GUI block in accordance with the systems and methods described herein.

FIG. 9 is a block diagram illustrating a training selector dialog GUI block in accordance with the systems and methods described herein.

FIG. 10 is a block diagram illustrating various circuitry in accordance with the systems and methods described herein.

FIG. 11 is a block diagram illustrating a computer GUI window 1100 in accordance with the systems and methods described herein.

FIG. 12 is a block diagram illustrating three system components graphically in accordance with the systems and methods described herein.

FIG. 13 is a block diagram illustrating signal generation and circuitry in accordance with the systems and methods described herein.

FIG. 14 is a block diagram illustrating State Estimation and Load Distribution (SLE) in accordance with the systems and methods described herein.

FIG. 15 is a block diagram illustrating an SLE comparison table in accordance with the systems and methods described herein.

FIG. 16 is a block diagram illustrating loads for load flow applications in accordance with the systems and methods described herein.

FIG. 17 is a block diagram illustrating a map that may be used in conjunction with load flow applications in accordance with the systems and methods described herein.

FIG. 18 is a block diagram illustrating loads for load flow applications in accordance with the systems and methods described herein.

FIG. 19 is a block diagram illustrating circuitry and a switch sequence in accordance with the systems and methods described herein.

FIG. 20 is a diagram of an example switching sequence editor in accordance with the systems and methods described herein.

FIG. 21 is a diagram of an example circuit in accordance with the systems and methods described herein.

FIG. 22 is a diagram of example control buttons in accordance with the systems and methods described herein.

FIG. 23 is a flow diagram of an example process flow in accordance with the systems and methods described herein.

FIG. 24 is a diagram of an example generator capability curve in accordance with the systems and methods described herein.

FIG. 25 is a diagram illustrating generator control in accordance with the systems and methods described herein.

FIG. 26 is a diagram of an example of generator synchronization in accordance with the systems and methods described herein.

FIG. 27 is a diagram illustrating a process flow including simulating triggers, evaluating actions, analyzing recommendations, and updating logic in accordance with the systems and methods described herein.

FIG. 28 is a diagram illustrating an example server system in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

### Purpose

In an example embodiment, ETAP OTS provides an environment that is effective for operator training and assistance. Operator training may be accelerated using dynamic graphical simulation of the power system with realistic response to every action. This may make training an ongoing process. The ability to simulate the sequence-of-operation using real-time data may be of fundamental importance in order to avoid inadvertent plant outages caused by human error, equipment overload, etc.

This document describes the “Operator Training Simulator System (OTS)” functional approach and solution offered by ETAP. Primarily, ETAP’s OTS works on live PMS system by interfacing with the PMS OPC servers to get the real time and historical measurement data status to get the exact operational network condition and behavior to initialize practical training sessions for the operators.

However, ETAP may be completely flexible in providing stand-alone OTS in combination of its ETAP-RT software and ETAP iCE hardware. ETAP-RT is a widely used software which has all the electrical component with its detailed physical, electrical, characteristics attributes to be used to model the network and behave as real time system. Thus, this may provide a very intuitive approach for the operator to create and understand the different configuration and scenario for training purpose.

### System Overview

In an example embodiment, the operator Training Simulator for PMS may have the capability of utilizing simulated, Real-Time, and Historical (Playback Data) for the purpose of simulating operations and analysis of the systems for better operational approach and training.

In an example embodiment, the software implemented in this system may have all the functionalities as used by the installed PMS/SCADA system. The system may be setup, so the system runs in two modes:

Standalone mode, which may include one or more of:
To utilize simulated for training purposes
To develop test and validate for newly added elements/network.

Interconnected mode, which may include one or more of:
To utilize simulated for training purposes
To utilize Real-Time and/or Historical Data
To develop test and validate for newly added elements/network.

ETAP OTS helps in conducting following functions:
Perform Switching of Electrical System
Start/Stop large HV/MV motors and observe the impact on the network
Simulate circuit breaker operation
Identify potential operating problem with auto generated alarms and events
Simulate various Power Analysis and load change
Predict operating time of protective devices
Predict system response based on operator actions
Perform “what if” operating scenarios
Conduct Load Shedding Simulation and Validation
Conduct Generation Management and Economic Dispatch application
Prepare unlimited Case studies for simulation.

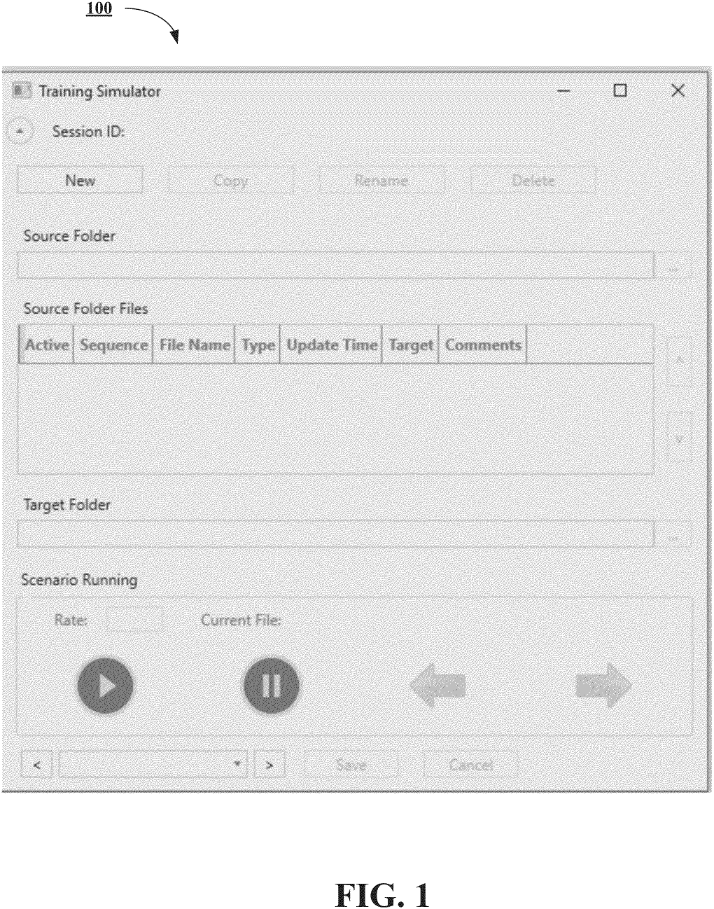

FIG. 1 is a block diagram illustrating a training simulator graphical user interface block 100 in accordance with the systems and methods described herein. In an example embodiment, ETAP OTS Orientation may be used. An ETAP Operator Training Simulator (OTS) may take advantage of OPCDEMO CSV function and simulate the real time scenarios when project is in online mode. It serves as a training tool for operator to be able to prepare the required interactions on ETAP after commission of the system.

Multiple sessions could be developed to prepare a training case using OTS and may include one or more of: (1) Prepare Data Source CSV file, (2) Create a session using OTS, and (3) Setup system to use OTS when project is online.

In an example embodiment, ETAP’s Operator simulation and training module may have the function of preparing operators to respond, in a quick and efficient way, to a large number of events and emergency contingencies that may occur in power systems through conducting numerous what-if analysis and predictive simulation. This tool may offer a full simulation and training interface, where the engineers can perform control action and check their impact on a virtual environment with real time system topology and measurements. The training architecture may apply an exact replica of real time and archived information of PMS servers to engineers connected to a simulation environment.

In an example embodiment, ETAP-RT PMS has built in feature to create an OTS application automatically, thus saving engineering man-hours. ETAP has automated procedure that copies the database through CSV file configuration, and then updated the same in ETAP SCADA integrator, allowing the OTS system to remain consistently updated with the main PMS SCADA - to maintain the change management consistently as actual in field.

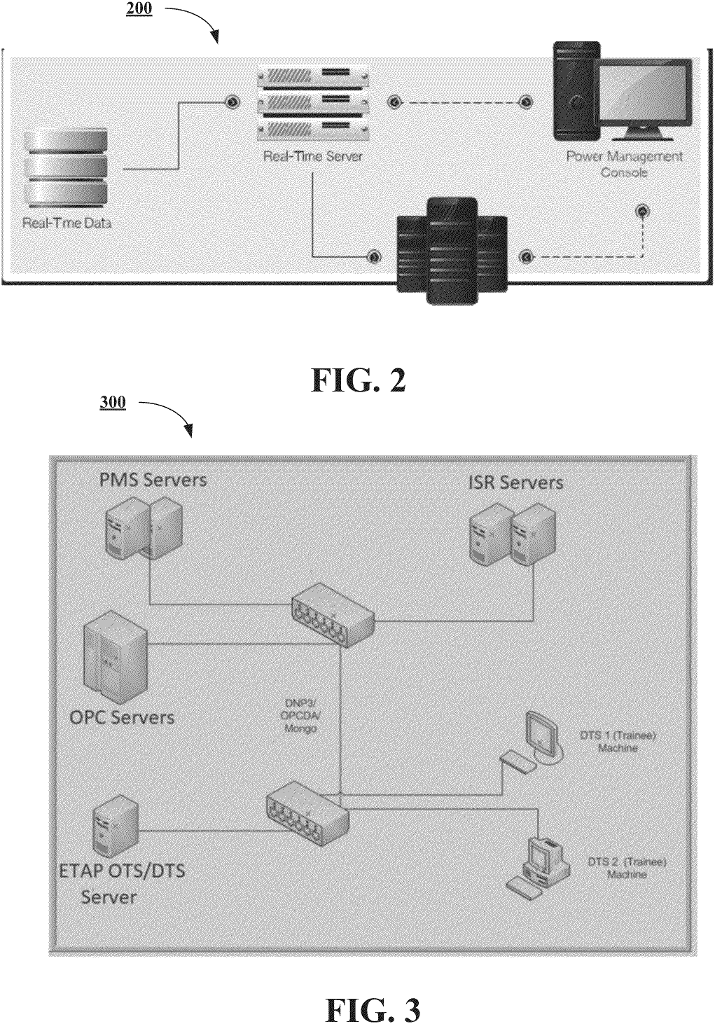

FIG. 2 is a block diagram illustrating an example computing system 200 in accordance with the systems and methods described herein. In an example embodiment, ETAP also brings extremely flexible approach to integrate the OTS with any third-party PMS/SCADA system. In an example embodiment, ETAP OTS is designed to handle generation, transmission, distribution, and industrial applications. An example embodiment may be based on existing power system electrical model and SCADA application, eliminates the need of extra configuration engineering.

In an example embodiment, a power flow algorithm can simulate all possible situations of the electrical system, including any complex events such as switching, overvoltage, protection, islanding conditions, etc. In an example embodiment, unlimited scenarios creation with integrated scenario wizard allows for running multiple scenarios in one go. In an example embodiment, real time and historical situations in the system can be saved to file and imported into the OTS. In an example embodiment, an engineer can use the same PMS console in OTS mode for quick integration.

In an example embodiment, changes may be automatically propagated to the OTS, keeping the databases synchronized. An example embodiment may be integrated with native SCADA protocols. In an example embodiment, ETAP OTS may be hardware and protocol agnostic which could easily integrated with any existing automation infrastructure.

What-if Simulation along with all the integrated power system analysis tool may allow to devise, plan, validate the robustness of the grid topology, identifying weaknesses and risk situations and plan the mitigation actions.

### System Architecture

FIG. 3 is a block diagram illustrating an example system architecture in accordance with the systems and methods described herein.

In an example embodiment, as illustrated below ETAP OTS could interface with PMS server, ISR server and OPC server to get the data. With these machines there may be 4 different configurations/Modes on OTS server machine. Two configurations to use Simulated Real-Time Data, the third to use Real-Time with Historical Data, the fourth to develop, Test and update the project. The configuration may be available already in the machine named:
Interconnected Simulated Data
Standalone Simulated Data
Development
Real-Time and Historical Data

In an example embodiment, ETAP Real-Time may employ an open and extremely flexible architecture that allows seamless communication with almost any data acquisition (DAQ) system, providing a hardware-independent platform.

In an example embodiment, ETAP Real-Time may be a true client-server configuration designed for Microsoft Windows platforms. The ETAP Real-Time server may be the central processing unit that manages the communication between the system, consoles, and controllers.

### Open Database

In an example embodiment, for the system topology, ETAP organizes and accesses its database using the Open Database Connectivity (ODBC) allowing the use of any database format for which an ODBC driver is available such as Microsoft Access, Microsoft SQL Server, and Oracle. In an example embodiment, ETAP users can integrate their data into the ETAP database using commercially available Database Management Systems (DBMS), or ETAP can integrate its data into any existing database

### Real Time, Historical and Interconnected Simulated Data

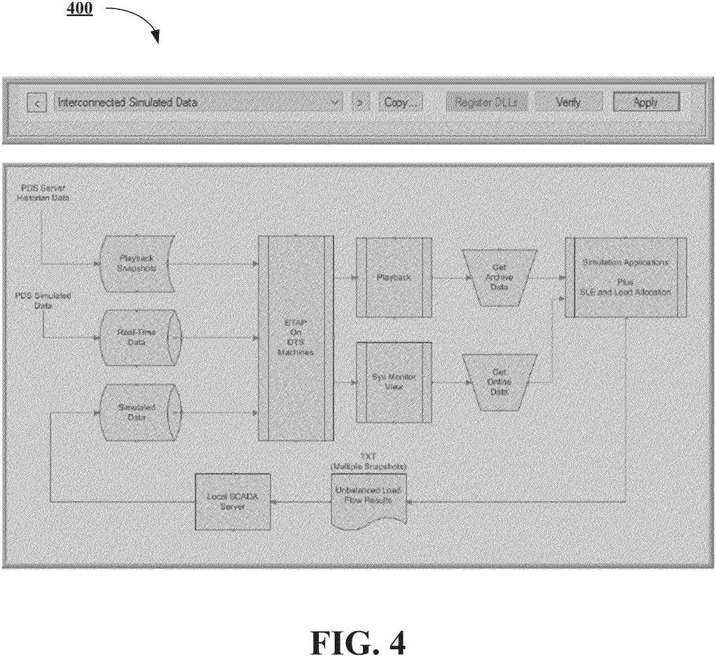

FIG. 4 is a block diagram illustrating data flow 400 in accordance with the systems and methods described herein. In an example embodiment, ETAP OTS may gather data from various sources as mentioned above. Below is the data flow for various data source. The system could get unlimited scenario that could be created to run the training. Under this configuration the data may be generated in snapshots by the ETAP Load Flow program. This may be done so the electrical data makes sense for applications such as state and load estimation and load allocation. In an example embodiment, the snapshots of load flow results may be saved in a TXT file. To activate this configuration, run the ETConfig application and apply the “Interconnected Simulated Data” configuration. Simulations and analysis available in OTS are included in the filing. Some example embodiments may include one or more of: (1) SCADA View, (2) State and Load Estimation, (3) Alarm, Event and SOE, (4) Reporting, (5) Trending, (6) Tabular Dashboard View, (7) Load Shedding, (8) Generator control, (9) Automatic Generation Control, (10) Economic Dispatch, (11) Load Flow, (12) Short-Circuit, (13) Arc Flash, (14) Device Coordination and Selectivity, (15) Sequence-of-Operation, (16) Motor Acceleration, (17) Harmonics, (18) Transient Stability, (19) Reliability Assessment, and (20) Optimal Power Flow

### OTS Predictive Simulation Analysis

In an example embodiment, ETAP OTS Online Predictive Simulation analysis may be a powerful analytical tool that allows for prediction of system behavior in response to operator actions and events via the use of real-time and archived data to give the operator real feeling of system behaviors in transient and steady state of operation.

OTS Predictive Simulation Software Features may include one or more of: (1) Simulate Circuit Breaker Operation, (2) Identify Potential Operating Problems, (3) Simulate Motor Starting and Load Change, (4) Predict Operating Time of Protective Devices, (5) Predict System Response Based on Operator Actions, (6) Perform “What If” Operating Scenarios, (7) Simulate Real-Time and Archived Data, (8) Operator Assistance and Training, (9) Islanding conditions, (10) Generator Startup and transient conditions.

Predictive Simulation Benefits may include one or more of (1) Full spectrum AC and DC analyses, (2) Emulate response of protective devices, (3) Evaluate protection and control actions, (4) Get online data on-demand, (5) Retrieve archived data for system analysis, (6) One-touch simulation, (7) View and analyze initial and post-disturbance actions, (8) Intelligent interactive graphical user interface, (9) Online simulation alerts, (10) Automatic scenario simulation using Project Wizard, (11) Accurate analysis with actual operating values, (12) Virtual operation of power systems, (13) Improve system planning and design, (14) Recognize and correct potential hidden problems, (15) Avoid “unforeseen” errors, (16) Prevent system interruption, (17) Determine under-utilization of system resources, (18) Identify the cause of operation problems, (19) Accelerate engineer and operator training, (20) Virtual test of operator / controller actions, and (21) Validate system settings

In an example embodiment, system operators and engineers may have instant access to online information and analysis tools that allow them to predict an outcome before system actions are taken. The ability to simulate the sequence-of-operation using real-time data may be of importance. Predictive simulation can avoid inadvertent plant outages caused by human error, equipment overload, etc. Predictive simulation provides an environment that is effective for operator training and assistance. Compared to traditional training methods, operator training may be accelerated using dynamic graphical simulation of the power system. This makes training an ongoing process.

ETAP eOTS addresses below Challenges and Concerns of operators may include one or more of: Avoid Unplanned Outages Caused by Human Error, e.g., including one or more of: How to reduce risks associated with potential missteps in operator actions? How to avoid mistakes caused by errors in switching plan sequence?

Reduce Start-up and Commission Times, including one or more of: How to ensure smooth and successful start-up and higher system availability? How to reduce operational risk during the initial phase of production and system start-up? Can the impact of the new facilities be simulated on the existing system before implementation?

Evaluate Operator Awareness and Readiness, including one or more of: Are the system dispatchers ready to response to malfunctions and emergencies? How to prepare operation staff for unexpected situations and contingency scenarios? How to effectively certify operators and confirm their readiness?

Benefits of ETAP eOTS may include one or more of Virtual Test of Operator Actions, Simulate and Track the Sequence-of-Operation, Ad Hoc and Pre-defined Evaluation Scenarios, Trainer-to-Trainees Learning Environment, and Software-in-the-Loop System Simulation.

For Virtual Test of Operator Actions, in an example embodiment, eOTS challenges the operators to become trained and knowledgeable about the behavior of the electrical power system and associated processes before facing the real-world operational situations. Through virtual simulation in response to operator actions contingences can be tested for normal and operations as well as emergency and abnormal conditions.

For Simulate and Track the Sequence-of-Operation, in an example embodiment, a model-driven power system training simulator to mimic the sequence-of-operation scenarios using real-time data to perform and validate actions such as configuration switching, generator synchronization, load shedding, motor startup, and more.

For Ad Hoc and Pre-defined Evaluation Scenarios, in an example embodiment, eOTS allows a trainer to create preconfigured scenarios to simulate realistic situations on the electrical system while allowing the operator to respond to the disturbances. The trainer may have the capability to inject events, messages, and disturbances both electrical and non-electrical during the execution of the training to any or all operator stations.

For Trainer-to-Trainees Learning Environment, in an example embodiment, a trainer may have the capability of fully evaluating the steps by operators. An example embodiment may include on screen playback, step-by-step logs, alarms and control logs, and electrical system response evaluation at the fingertips of the trainer using real and simulated data in a trainer-trainee environment.

For Software-in-the-Loop System Simulation, in an example embodiment, eOTS in a fully closed-looped system while simultaneously using Real-Time data using etap SIL™ -Software-in-the-Loop technology. An example embodiment provides a training environment for operators that matches the operation of the power management system with dynamic response of the electrical system including the electrical system’s protection and control systems.

For Trainee Environment, in an example embodiment, the trainees may have at their disposal: Simulated, Real-Time, or Historical data for Scenario initialization. The following data may be provided: Simulated data, Real Time data may be coming from the field, and Historical Data can be queried to initiate scenarios. Amount of historical data is limited to Historian Disk space.

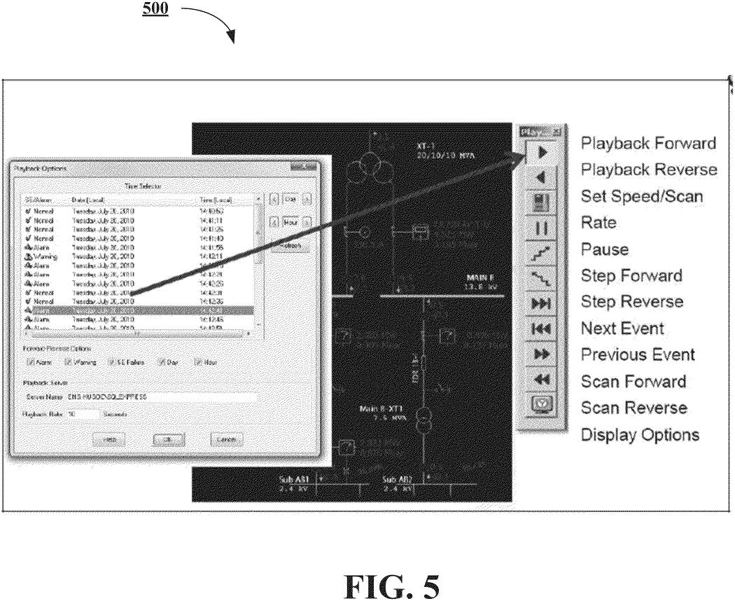

FIG. 5 is a block diagram illustrating example recordings of actions 500 in accordance with the systems and methods described herein. Each action (opening/closing switching devices) may be recorded along with the reaction of the system to the action.

During scenario operator actions a system may provide one or more of: (1) Display operation data in ETAP OLV, HMIs, (2) Display Configured Alarms, and (3) Populate Event Log.

Display analytical alarms for configured executions of: (1) Load Flow, (2) Short-Circuit, (3) HA and Freq Scan, (4) Motor Starting, (5) Transient Stability, and (5) Trainer Environment.

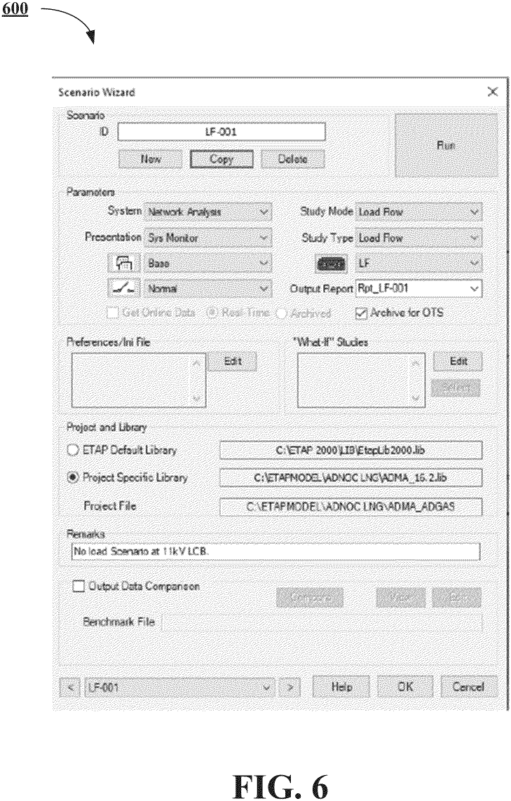

FIG. 6 is a block diagram illustrating example GUI I/O block for a scenario 600 in accordance with the systems and methods described herein. An instructor may have the ability to create and save operation scenarios including states and conditions such as: (1) Operation levels, (2) Configurations, and (3) Alarm conditions. In an example embodiment, new conditions may be sent to trainees Review and evaluation tools of trainee actions. Conditions may be able to be sent at the beginning of training or while can be sent at the discretion of the trainer. This may allow a range of flexibility for a trainer. A trainer may be able to adjust scenarios based on feedback from the trainees. When trainees appear to struggle with a specific scenario, the trainer can provide more example before continuing to other situations. In an example embodiment, one or more of the following may be included: (1) Unlimited Scenario Creation, and (2) Provide pre-configured Training Exercises and What-if Exercises

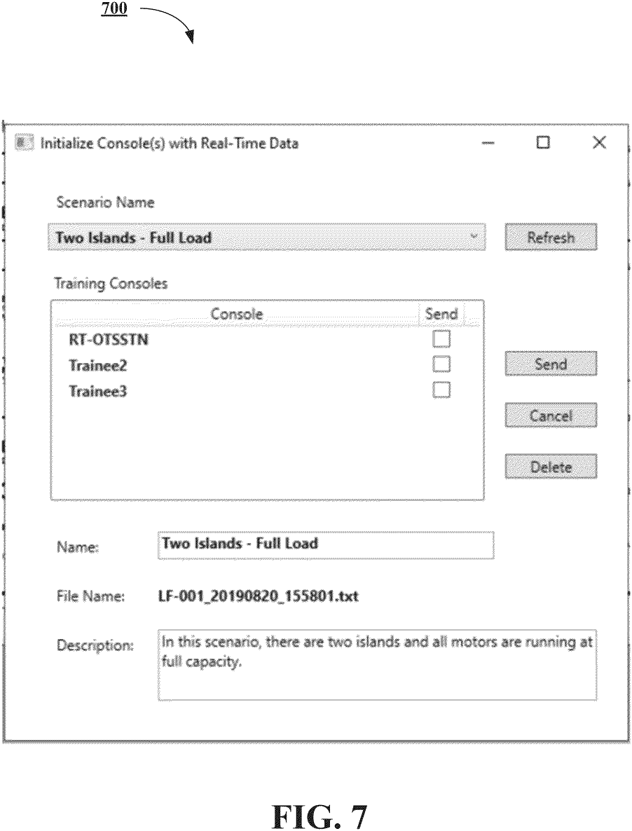

FIG. 7 is a block diagram illustrating example GUI I/O to initialize a console 700 in accordance with the systems and methods described herein.

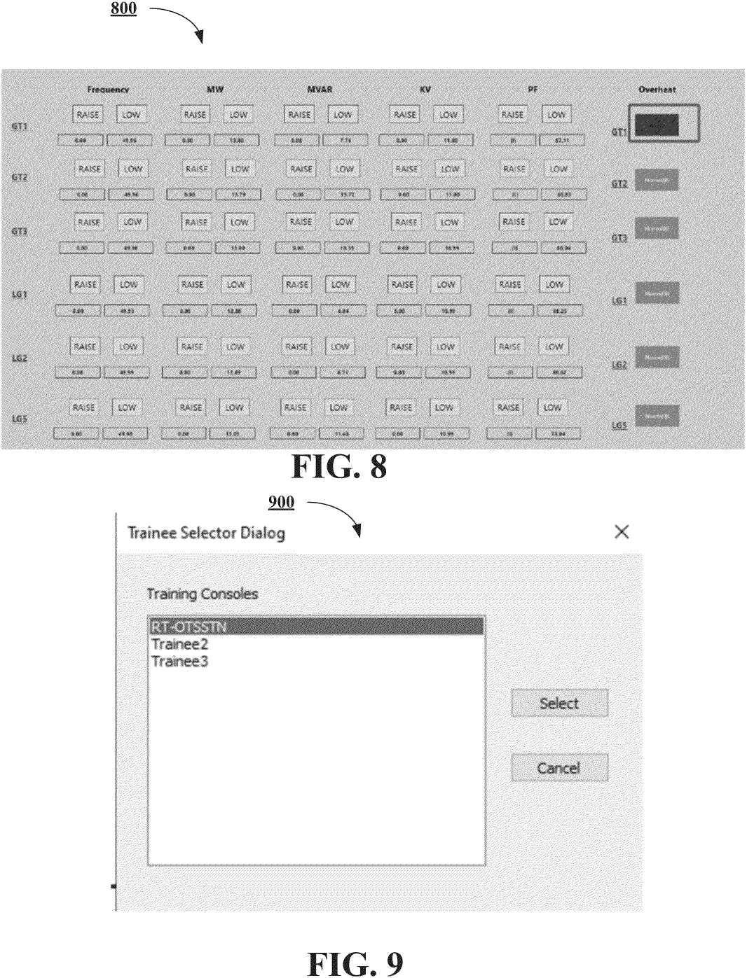

FIG. 8 is a block diagram illustrating a training session review and audit GUI block 800 in accordance with the systems and methods described herein. In an example embodiment, trainer can launch Trainee’s HMI screen in Trainer workstation and view the updates on the Trainee machine with each action and inject Ad-hoc messages and alarms to review the response. In an example embodiment, a trainer can launch Trainee Event Playback dialog and view the alarms, events and step by step action taken by the Trainee for the given configuration.

FIG. 9 is a block diagram illustrating a training selector dialog GUI block 900 in accordance with the systems and methods described herein.

### Steps for Setting eOTS Session

To setup a training session, trainer can easily set up an environment or configuration for the trainee to perform training exercise: (1) Launch ETAP and connect to either Real-Time or Historian Server, (2) Launch Scenario Wizard and select the Training Configuration, (3) Launch Initialization Toolbar and Send file to the Trainee, (4) Trainee to accept the Training session and perform actions, (5) Trainer connect to Trainee and monitor actions of Trainee, (6) Trainer Review Session and Report, (7) Network Topology Builder, (8) In an example embodiment, Network Topology Builder (NTB) may be a user-friendly environment for creating and managing network databases used for schematic network visualization.

In an example embodiment, NTB offers a set of core tools, embedded analysis modules, and engineering libraries that allow you to create, configure, customize, and manage your smart grid model. In an example embodiment, core tools allow you to integrate 3-phase and 1-phase network one-line diagrams quickly and easily with unlimited buses and elements including detailed instrumentation and grounding components.

In an example embodiment, NTB includes an intelligent one-line diagram, element editors, configuration manager, report manager, project and study wizards, multi-dimensional database, theme manager, data exchange, and user access management. Engineering libraries may provide complete verified and validated data based on equipment manufacturer’s published data. Some examples may include one or more of: (1) Built-in intelligent graphics, (2) Network nesting, (3) Integrated 1-Phase, 3-Phase, and DC systems, (4) Integrated AC, DC, and grounding systems, (4) Multiple generators and grid connections, (5) Display results on one-line diagrams, (6) Graphical undo / redo, (7) User-defined symbol text, (8) Voltage propagation, (9) Graphical alignment tools, (10) Group rotation of elements, (11) Customizable font types, styles, and colors, (12) Customizable display of ratings and results, (13) Graphical display of equipment impedance and grounding, (14) Graphical display of overstressed devices and alerts, (15) Hide and show protective devices and grounding systems, (16) Propagation of nominal and rated voltage, (17) Propagation of phase connection, (18) Text box editor with dynamic link to properties, (19) OLE object and ActiveX control integration, (20) Intelligent text box and hyperlink bookmarks, (21) Customizable output reports via Crystal Reports®, (22) Batch printing with view-dependent printer settings, (23) User-friendly plotting, (24) Network Topology Processor

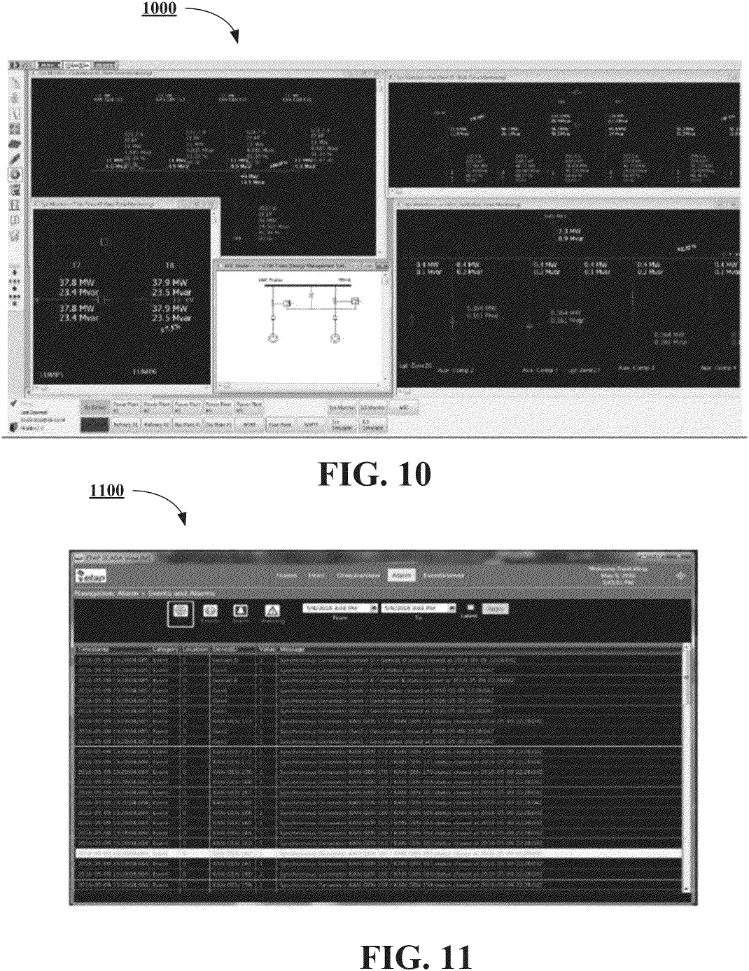

FIG. 10 is a block diagram illustrating various circuitry 1000 in accordance with the systems and methods described herein. To estimate and analyze the state of the entire electrical network, a network topology may be available and kept up to date in real-time. In an example embodiment, ETAP Network Topology Processor (NTP) continuously retains and updates electrical system topology such as branch impedances, loading, connectivity, breaker status, etc. In an example embodiment, ETAP NTP may be the foundation for real-time applications like state estimation. In an example embodiment, NTP may also provide dynamic analysis of the electrical topology of the system and reports overall conditions to the operator.

FIG. 11 is a block diagram illustrating a computer GUI window 1100 in accordance with the systems and methods described herein.

In an example embodiment, powerful displays provide quick indication of outage customers and other abnormal network conditions. In an example embodiment, one or more of the following may be provided: (1) Intelligent one-line diagram, (2) Multi-level nesting of subsystems, (3) Multi-color symbols, (4) Interfaces management switching device, (5) Unique multi-dimensional database, (6) Node-branch network connectivity, (7) Connectivity status of equipment, (8) Information concerning equipment out of service, (9) Open-ended lines and transformers, (10) De-energized equipment, (11) SCADA HMI friendly coloring for protective devices, (12) Location / Area based coloring, (13) Graphically assign Area, Zone, Region, (14) Assign graphics to composite networks, and (15) Network islands

In an example embodiment, ETAP can track and record unusual activities with event logging and alarming tools. This provision may allow for early detection and announcement of problems before a critical failure takes place. An example embodiment changes in system information may be displayed graphically and logged. The calculated results may be compared with metered parameters to provide pop-up alarms for equipment with missing and out-of-range data. Examples may include one or more of: (1) Annunciate local and system-wide alarms, (2) Warnings based on equipment ratings, (3) Alarm priority setting and event triggering, (4) Annunciate out-of-range measurements, (5) Graphical, tabulated, and audible annunciation, and (6) Predict abnormal conditions and critical failures.

In an example embodiment, Power Monitoring Dashboards may allow visualizing of the data in user-definable formats. Power Monitoring Dashboards may assist in the assessment of a situation in real-time basis per measurement tag or for an entire set of inputs. Some examples may allow a user to instantly, e.g., quickly, view and analyze performance indicators and process data such as gas, water, oxygen, nitrogen, and air networks for complete energy monitoring.

### Digital Twin Database Modeling

In an example embodiment, ETAP organizes an electrical system into a single project through its digital twin model. Within this project, ETAP may create three major system components:

### Presentation

In an example embodiment, unlimited, independent graphical presentations of the one-line diagram that represent design data for any purpose (e.g., such as impedance diagram, study results, or plot plan).

### Configuration

In an example embodiment, unlimited, (e.g., practically unlimited, a large enough number to generally not be limiting) independent system configurations that identify the status of switching devices (open and closed), motors and loads (continuous, intermittent, and spare), generator operating modes (swing, voltage control, reactive power control, power factor control) and MOVs (open, closed, throttling, and spare) may be provided.

### Revision Data

In an example embodiment, Base Data and unlimited Revision Data IDs that keep track of the changes and modifications to the engineering properties (for example, nameplate or settings) of elements.

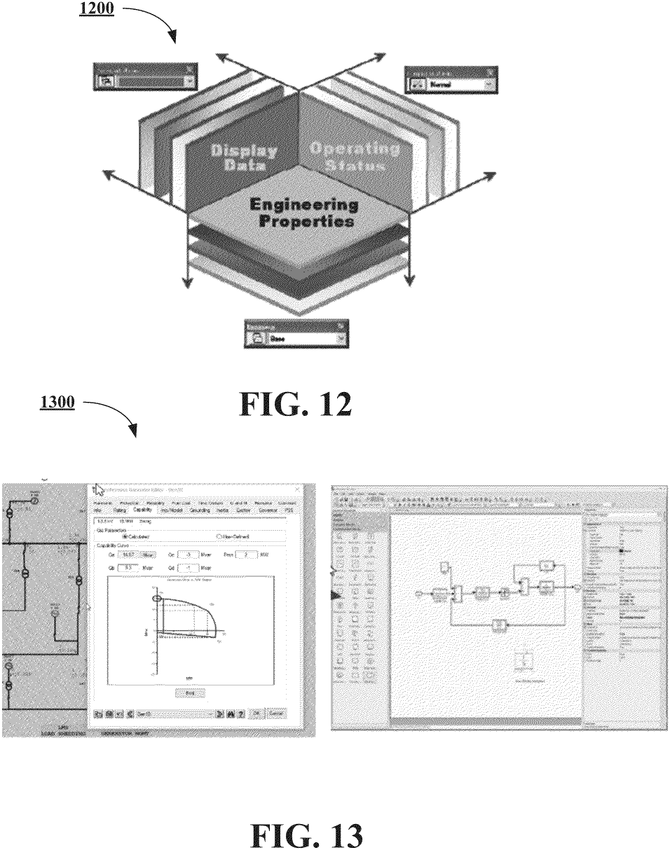

FIG. 12 is a block diagram illustrating three system components graphically 1200 in accordance with the systems and methods described herein. In an example embodiment, these three system components may be organized in an orthogonal fashion to provide great power and flexibility in constructing and manipulating your ETAP project. Using this concept of Presentation, Status Configuration, and Revision Data, you can create numerous combinations of networks of diverse configurations and varying engineering properties that allow you to fully investigate and study the behavior and characteristics of the electrical networks using one database. This means that you do not need to copy your database for different system configurations, “What If” studies, etc.

In an example embodiment, ETAP relies on a three-dimensional database concept to implement all Presentations, Configurations, and Base and Revision Data. The use of this multi-dimensional database concept allows you to independently select a Presentation, Configuration Status, or Revision Data within the same project database.

In an example embodiment, these selections can be used in conjunction with multiple loading categories and multiple study cases to quickly and efficiently perform system design and analysis, while avoiding inadvertent data discrepancies created when multiple copies of a single project file are used to maintain a record of various system changes.

FIG. 13 is a block diagram illustrating signal generation and circuitry 1300 in accordance with the systems and methods described herein. The signal generation and circuitry 1300.

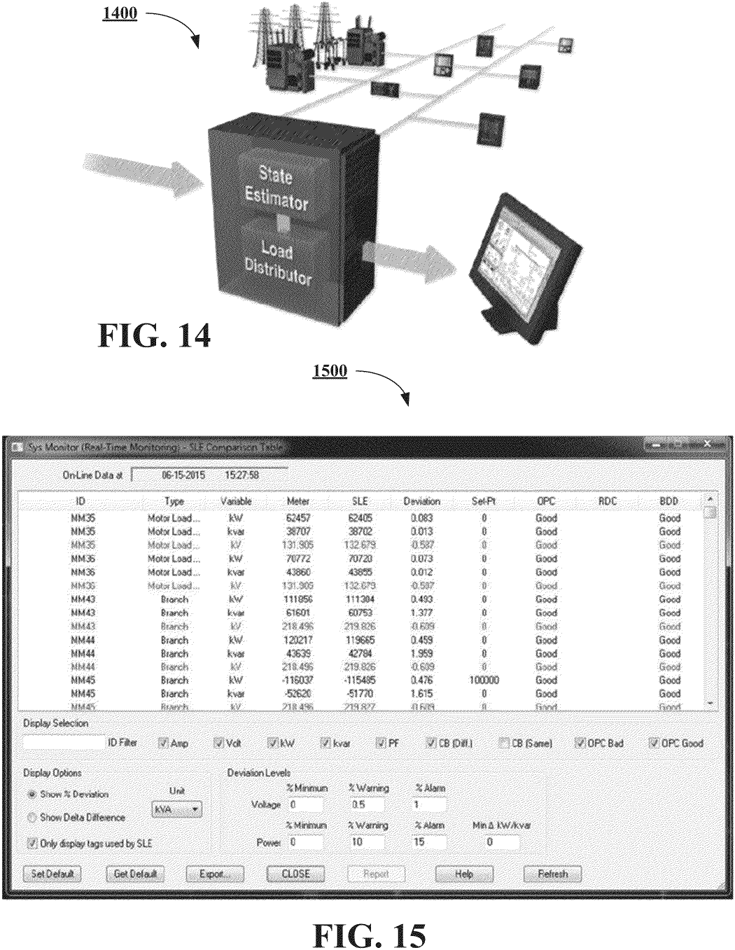

FIG. 14 is a block diagram illustrating State Estimation and Load Distribution (SLE) 1400 in accordance with the systems and methods described herein.

In an example embodiment, ETAP State Estimation processes telemetry data such as power measurements to obtain an estimate of the magnitudes and phase angles of bus voltages in the actual power systems.

In an example embodiment, using these values, the State Estimator examines the data for obvious data errors, determines those portions of the network which have sufficient telemetry to be observable, generates artificial measurements (called “pseudo” and “virtual” measurements) at locations where they are required for observability, and then computes the estimate of the system voltages and the tap positions of tap changing transformers. Some example embodiments may include one or more of: (1) State estimation of non-observable subsystems, (2) Comparison of measured vs. estimated values, (3) Dependable and fast convergence solution, (4) Minimum system measurements requirement, (5) State-of-the-art estimation techniques, (6) Data consistency checking, (7) Bad data and error detection, (8) Load distribution, (9) State estimation comparator.

FIG. 15 is a block diagram illustrating an SLE comparison table 1500 in accordance with the systems and methods described herein. The SLE comparison table 1500 includes a number of entries, including identification (ID), type, variable, meter, SLE, deviation, set point, OPC, RDC, and BDD.

### Power Applications - Load Flow Application

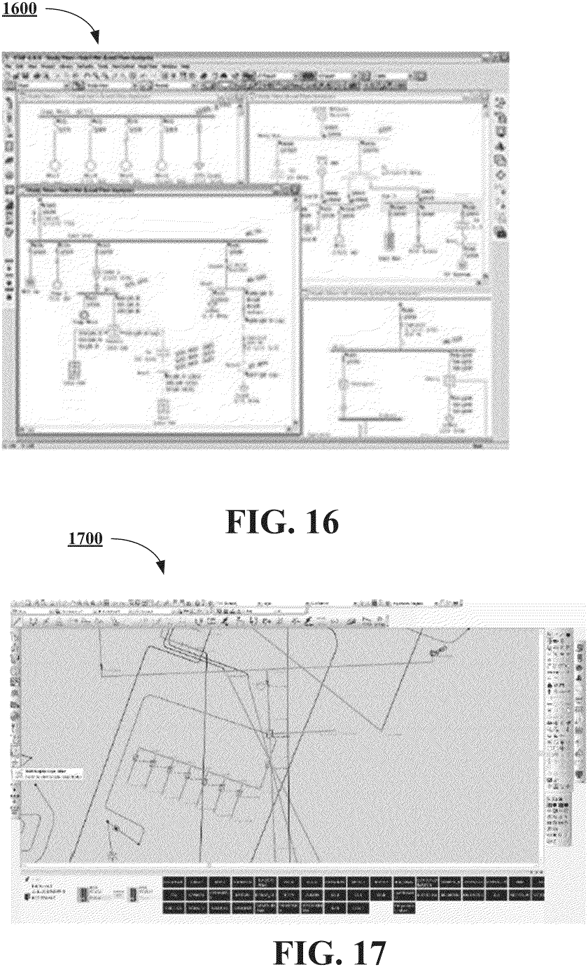

FIG. 16 is a block diagram illustrating loads for load flow applications 1600 in accordance with the systems and methods described herein. The loads for load flow applications 1600 includes example circuit diagrams illustrating example loads. The loads for load flow applications 1600 is discussed in more detail below.

In an example embodiment, the ETAP Load Flow Analysis module calculates the bus voltages, branch power factors, currents, and power flows throughout the electrical system. ETAP allows for swing, voltage regulated, and unregulated power sources with multiple power grids and generator connections. It can perform analysis on both radial and loop systems. ETAP allows you to select from several different methods to achieve the best calculation efficiency.

In an example embodiment, the ETAP Load Flow can operate in an offline mode utilizing user defined loading and generations. ETAP-LF may also interfaces with the online mode utilizing the status of the real-time system and estimated loading and voltages from the state and load estimation calculations in Real-Time mode.

In an example embodiment, a robust and efficient power flow solution method may be able to model special features of distribution systems with sufficient accuracy. With ETAP’s Distribution Load Flow module, you can easily model your unbalanced system with detailed representation of component unsymmetrical characteristics. Accurate and reliable results may be available describing your system’s unbalanced operating conditions.

FIG. 17 is a block diagram illustrating a map that may be used in conjunction with load flow applications 1700 in accordance with the systems and methods described herein. The load flow applications 1700 is discussed in more detail below. Unbalanced power flow using real-time operating data from SLE may monitor one or more of the following: (1) Single-phase and unbalanced 3-phase modeling, (2) Unbalanced and nonlinear load modeling, (3) Phase and sequence voltage, current, and power, (4) Voltage and current unbalance factors, (5) Automatic device evaluation, (6) Unbalanced loads and branches, (7) Machine internal sequence impedances, (8) Machine/transformer various grounding types, (9) Modeling of transformer winding connections, (10) Transmission line coupling between phases of one line and multiple lines, (11) Loads of constant power, constant impedance and constant current, (12) Generic load as function of voltage and frequency, (13) Transformer load tap changers (LTC / regulators), (14) Phase-shifting transformers, (15) Swing, voltage regulated, and unregulated power sources, (16) Auto-adjust voltage regulator settings, (17) Current-injection method, (18) Five levels of automatic error checking, (19) Save solution control parameters for each scenario, (20) Make changes to your system and re-run studies instantly, (21) Conduct unlimited “what if” studies within one database 10,000+ bus capability.

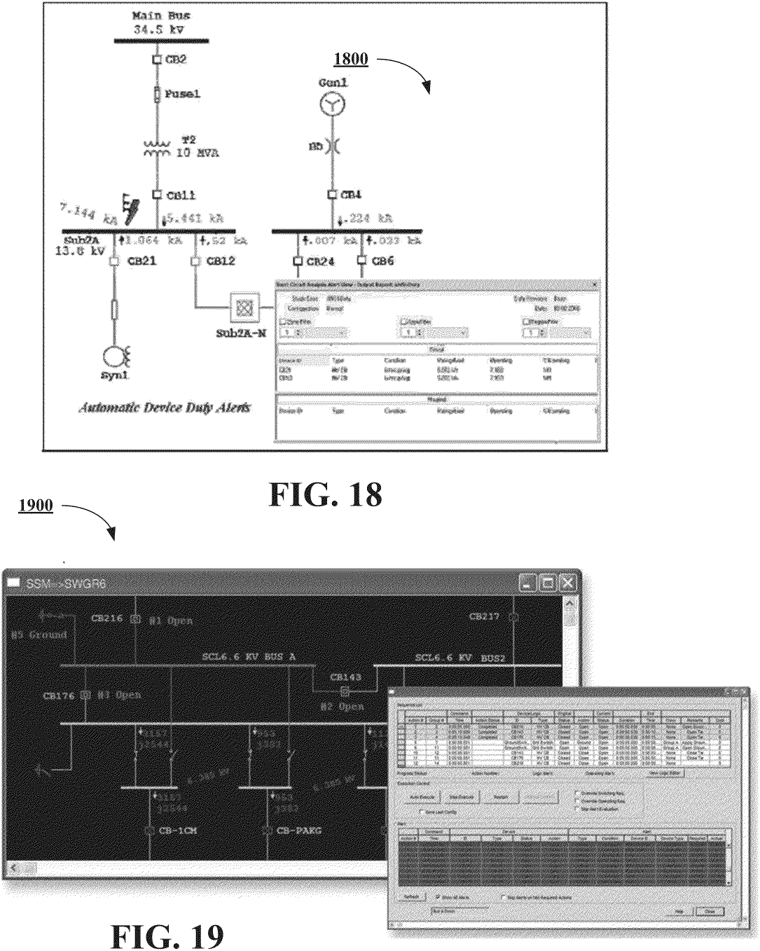

FIG. 18 is a block diagram illustrating loads for load flow applications 1800 in accordance with the systems and methods described herein. The loads for load flow applications 1600 includes example circuit diagrams illustrating example loads. The loads for load flow applications 1600 is discussed in more detail below.

### Short Circuit Analysis/Fault Analysis

In an example embodiment, the ETAP Real-Time Short-Circuit Analysis program analyzes the effect of three-phase, line-to-ground, line-to-line, and line-to-line-to-ground faults on the electrical distribution systems. The program may calculate the total Short-Circuit currents as well as the contributions of individual motors, generators, and utility ties in the system. In an example embodiment, fault duties may be in compliance with the latest editions of the ANSI/IEEE Standards (C37 series) and IEC Standards (IEC 909 and others).

In an example embodiment, short-Circuit Analysis may be especially valuable in cases of looped systems where the system configuration is readily changeable by operator actions (for example, opening and closing tie breakers). The operator can test whether Short-Circuit capacities are exceeded for a given system configuration. The simulator may identify equipment whose capacity could be exceeded in the event of a three-phase fault. One of the main purposes of Short-Circuit Analysis may be to calculate and provide the fault current contribution of relay and fuse operations in some examples. Some examples may perform one or more of the following: (1) Short Circuit Software Features and Capabilities, (2) ANSI/IEEE Standards C37 and UL 489, (3) IEC Standards 60909 and 61363, (4) GOST Standards R-52735, (5) Automatic device evaluation for 3-phase, 1-phase, and panel systems, (6) Determine worst case device duty results, (7) Display critical and marginal alerts, (8) Load terminal short circuit calculation, (9) Integrates with Star protective device coordination, (10) Seamless transition to Arc Flash Analysis, (11) Generator circuit breaker evaluation, (12) Short-Circuit Reporting, (13) Automatic 3-phase device evaluation, (14) Single-phase and panel systems device evaluation, (15) Device evaluation based on total or maximum through fault current, (16) Automatically adjust conductor resistance and length (both lines and cables), (17) Advanced handling of Wind Turbine Generator, (18) Global or individual device impedance tolerance adjustments for maximum and minimum fault currents, (19) Include / exclude fault impedance modeling for unbalanced faults, (20) Include / exclude shunt admittance for branches and capacitive loads (unbalanced faults), (21) Graphical or tabular bus fault selections, (22) Automatically determine fault currents at motor terminals without the need to add additional buses, (23) Phase-shifting transformers, (24) Grounding models for generators, transformers, motors, and other loads, (25) Motor contribution based on loading category, demand factor, or both, (26) Short Circuit software extracts manufacturer published data from the libraries for thousands of devices

FIG. 19 is a block diagram illustrating circuitry and a switch sequence 1900 in accordance with the systems and methods described herein. The switch sequence 1900 includes example circuit diagrams illustrating example loads. The switch sequence 1900 is discussed in more detail below.

### Switching Sequence Management / Work Order Management

In an example embodiment, switching Management allows the dispatcher to build a complete switching program using a graphical user interface and execute the switching plan all in one step. The switching sequence contains a list of switching devices and time of execution for circuit breakers, load disconnects, and ground disconnects. Before any switching sequence is executed, the application may verify whether the sequence is compliant with safety switching procedures and requests confirmation during execution of each step before proceeding to the next step in order to avoid inadvertent switching.

In an example embodiment, switching plan may be configured for automatic transfer of bus loads on double-ended bus configurations thus replacing the step-by-step method of switching for double-ended bus configurations that require manual bus load transfer. Switching sequences can be ranked based on de-energized time, non-delivered energy, and the order of switching allowing easy comparison between different variations of the plan. Some examples may include one or more of: (1) User-friendly switching plan builder, (2) Point and click selection of switching device from the one-line diagrams, (3) Graphical display of selected switching devices, (4) Multi-level switching request approval, (5) Assignment of user-definable and interlock logic per each switching device, (6) Checking of selected switching plans against forbidden or potentially hazardous actions, (7) Unlimited switching plans each with an unlimited number of switching actions, (8) Switching order reports include switching mode, start / stop time, and nature of work, (9) Simulate and evaluate switching plans in all states prior to execution, (10)

### Operator (Human Machine) Interface and Displays

The operator interface includes two sections: Creating Switching Sequence and Executing Switching Sequence.

### Creating Switching Sequence

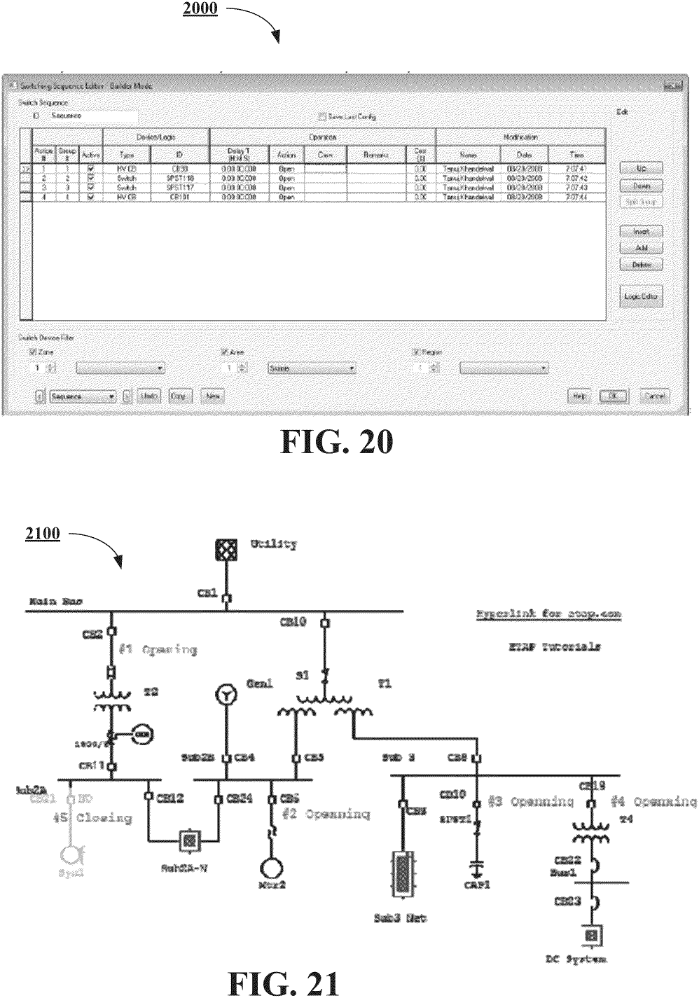

FIG. 20 is a diagram of an example switching sequence editor 2000 in accordance with the systems and methods described herein. FIG. 21 is a diagram of an example circuit 2100 in accordance with the systems and methods described herein.

In an example embodiment, a switching sequence can be created using the Switching Sequence editor or using the ETAP OLV.

### Switching Sequence Editor

In an example embodiment, the Switching Sequence editor can be opened from the ETAP Project View. Using the Switching Sequence editor, the operator can create a new switching sequence or modify an existing one. The Insert, Add, and Delete buttons may allow the operator to add or delete an action. The Up, Down, and Split Group buttons may allow the operator to modify the sequence for the actions.

### Switching Sequence Editor

An action in the sequence can be:

In an example embodiment, a change of status of a switching device, which includes tasks: checking pre-conditions, performing the switching, and carrying out post-actions for the switching.

An example embodiment may include pre-defined system control logic to make a switching based on system operating condition.

An example embodiment may include a procedure for system monitoring and verification, such as checking temperature of equipment or verifying isolation points being locked.

### Creating a Switching Sequence Using ETAP One-Line View

In an example embodiment, the Sequence Builder mode from the ETAP Switching Sequence Management module, the operator can use the ETAP one-line diagram to automatically generate a sequence as he/she applies mouse operation on a switching device on the OLV.

### Switching Sequence Simulation

In an example embodiment, a switching sequence can be simulated in ETAP using the Switching Sequence View. The simulation can be carried out in two methods: Step-by-Step or Automatic.

### Step-by-Step Simulation

In an example embodiment, in the Step-by-Step Simulation, the operator carries out the sequence step-by-step. In each step, ETAP simulates the actions and verifies operating conditions. If there are any failed conditions or abnormal operating conditions, alerts may be raised and displayed in the Alert section of the Switching Sequence View.

In an example embodiment, as the simulation proceeds, status of actions is displayed dynamically in the action list and color flagged to indicate its status.

In an example embodiment, the alerts generated in each action are displayed in the Alert list with different colors to indicate type and level of alerts.

### Automatic Simulation

In an example embodiment, in the Automatic Simulation, the simulation of the whole sequence is carried out unless there are alerts raised for an action. In this case, the operator can either skip the action and continue or abort the simulation.

### Simulation Report

In an example embodiment, the simulation report includes a list of all steps in the simulation, which can be used to conduct the switching sequence for the real system. In the list, it may have all switching steps, system control logic and procedures.

In an example embodiment, the report may also include all alerts generated in the simulation with the step alerts that were generated.

### Online Switching Sequence Simulation

In an example embodiment, a pre-defined switching sequence can be executed online in a similar way as in the offline simulation, but with special features applicable for online calculation only, such as confirmation of actions, acknowledgement of alerts, etc.

### Step-by-Step Control

In an example embodiment, in the Step-by-Step Simulation, the operator carries out the sequence step by step. In each step, ETAP carries out calculations using online data to predict system behavior for the next action and check operating conditions. When there are any failed conditions or abnormal operating conditions, alerts may be raised and displayed in the Alert section of the Switching Sequence View.

In an example embodiment, the operator decides if the next action shall be carried out, shall be skipped, or the process shall be aborted based on the alert’s prediction.

In an example embodiment, each action carried out may be confirmed before the actions ’

### Real Time Motor Acceleration

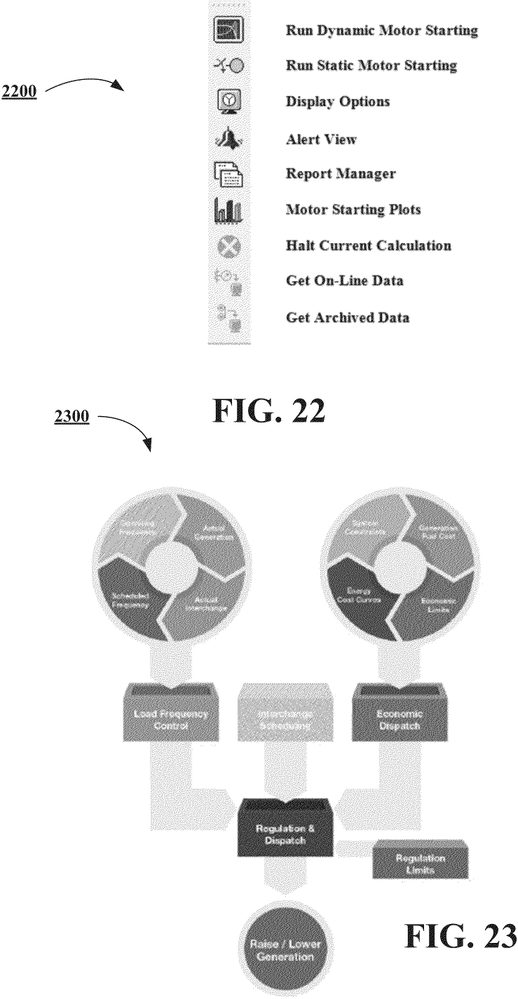

FIG. 22 is a diagram example control buttons 2200 in accordance with the systems and methods described herein. In an example embodiment, during the motor starting period, the starting motor appears to the system as a small impedance connected to a bus. It draws a large current from the system, about six times the motor rated current, which therefore results in voltage drops in the system and imposes disturbances to the normal operation of other system loads. Since the motor acceleration torque is dependent on motor terminal voltage, in some cases the starting motor may not be able to reach its rated speed due to extremely low terminal voltage. This may make it necessary to perform a motor starting analysis. The purpose of performing a motor starting study may be twofold: to investigate whether the starting motor can be successfully started under the operating conditions, and to see if starting the motor may seriously impede the normal operation of other loads in the system.

In an example embodiment, ETAP provides two types of motor starting calculations: Dynamic Motor Acceleration and Static Motor Starting. In the Dynamic Motor Acceleration calculation, the starting motors may be represented by dynamic models and the Motor Acceleration module simulates the entire process of motor acceleration. This method may be used to determine if a motor can be started and how much time is needed for the motor to reach its rated speed, as well as to determine the Click this button to perform a time-domain simulation for starting and/or switching off motors and static loads. Accelerating motors may be modeled dynamically for this study; therefore, related motor parameters such as dynamic model (or LR model for synchronous motors), inertia, and starting load may be specified. Motors (induction and synchronous) and static loads can be switched off and on in any event created.

### Run Static Motor Starting

In an example embodiment, click this button to perform a time-domain simulation for starting and/or switching off motors and static loads. For this study, starting motors are modelled as constant impedance loads calculated from their locked-rotor currents with a user-defined acceleration time.

In an example embodiment, required parameters for this study may include the locked-rotor current and power factor, acceleration time at no-load and full-load, and starting load.

In an example embodiment, motors (induction and synchronous), MOVs, and static loads can be switched off and on in any event created.

### Transient Stability

In an example embodiment, the purpose of Transient Stability Module is to investigate the system dynamic responses and stability limits of the power system before, during, and after system changes or disturbances. Dynamic characteristics of the power system may be modelled, user-defined events and actions implemented to solve the system network equation and machine differential equations interactively to find out system and machine responses in time domain. These responses may be used to determine the system transient behavior, make stability assessment, set protective device settings, and apply the necessary remedy or enhancement to improve the system stability.

In an example embodiment, system disturbances are a source of instability that can cause loss of synchronization, stalling or overloading of generators and motors. Catastrophic failure of large parts of the power system can result, along with plant damage.

In an example embodiment, the dynamic performance of the system with respect to the disturbances listed below, but not limited to, may be studied for one or more of the following cases: (1) 3-phase fault, (2) Unbalance fault, (3) Fault clearance, (4) Motor Starting, (5) Loss of transformers, (6) Loss of loads, (7) Loss / tripping of generators / grid source, and (8) Load Shedding.

### User Defined Dynamic Models

In an example embodiment, the ETAP User-Defined Dynamic Models (UDM) program is a graphic logic editor (GLE) interpreter tool which allows the creation of user-defined governor, exciter, and Power System Stabilizer (PSS) models for synchronous machines, generic load and wind turbine generator models. This module may allow the models to be linked to ETAP’s transient stability program. The models can be built in the ETAP UDM Graphic Logic Editor or can be imported from MATLAB Simulink® files. ETAP uses these dynamic models at run time when conducting Transient Stability Studies. This tool may be fully integrated into ETAP to allow the creation of dynamic models.

In an example embodiment, the main application of the UDM module is to create and tune (validate) dynamic control elements which are not part of the standard ETAP dynamic model library (built-in models). One or more of the following types of controllers / dynamic models can be created with UDM: (1) Synchronous Motors Exciter / AVR models, (2) Synchronous Generator Exciter / AVR models, (3) Synchronous Generator Turbine, Engine / Speed Control models, (4) Synchronous Generator PSS (Power System Stabilizer) models, and (5) Wind Turbine Generator Models

### Generic Load Models (Lumped Load Element Dynamic Models)

In an example embodiment, the UDM interface also has the capability to assist in the selection of parameters or settings for each of the controllers or dynamic models listed above. This capability is called Dynamic Parameter Estimation and Tuning or DPET for short. DPET can be used to estimate the values of the parameters which make the controllers respond as similar as possible to a field measured response (i.e. measurements from a staged test or field recorded disturbance). The tuning of the UDM model response is accomplished by using an iterative approach which automatically adjusts the tunable settings/parameters in the model to make the controller response match that of field recorded data. This process may also be known as automatic model validation parameter tuning.

### Automatic Generation Control Simulation Analysis

FIG. 23 is a flow diagram 2300 of an example process flow in accordance with the systems and methods described herein. In an example embodiment, automatic Generation Control (AGC) software calculates the required parameters or changes to optimize the operation of generation units. The automatic generation control software uses real-time data such as frequency, actual generation, tie-line load flows, and plant units’ controller status to provide generation changes.

In an example embodiment, automatic Generation Control Software Features may include one or more of: (1) Advisory and Simulation Mode Analysis, (2) Dynamic Model of Generators, (3) Control system simulator, (4) Multi-Area Automatic Generation Control, (5) Load Frequency Control, (6) NERC Performance Standard, (7) Generator Power Sharing (Real and Reactive), (8) Minimize Area Control Error (ACE), (9) Maintain frequency at the scheduled value, (10) Operate system with adequate security and economy, (11) Maintain net power interchanges, (12) Maintain economic power allocation, (13) Share MW and MVAR proportionally amongst various generation units, (14) Multiple pre-configured automatic generator control modes.

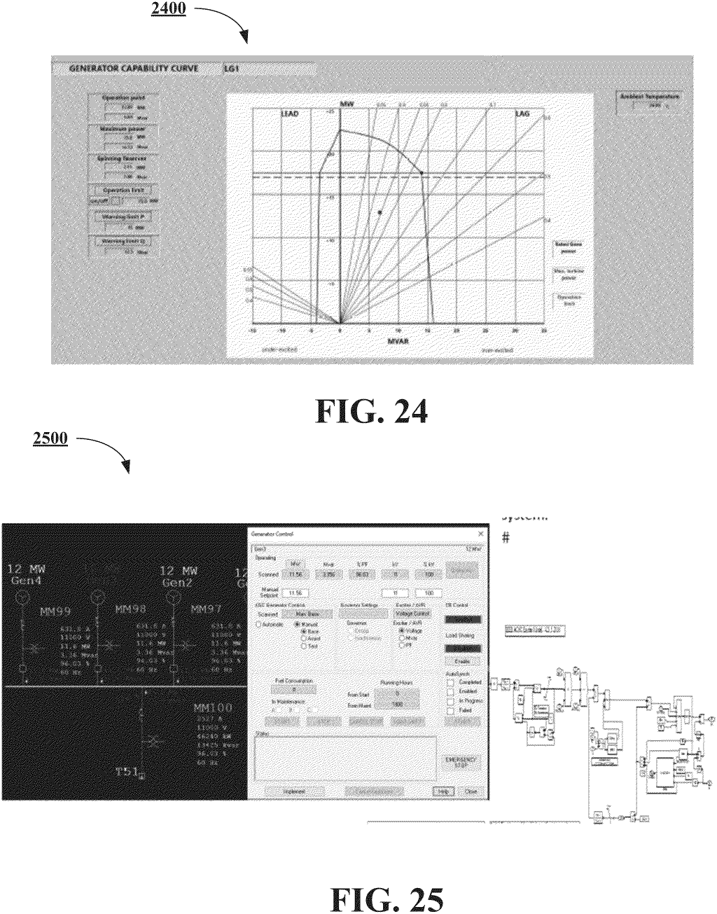

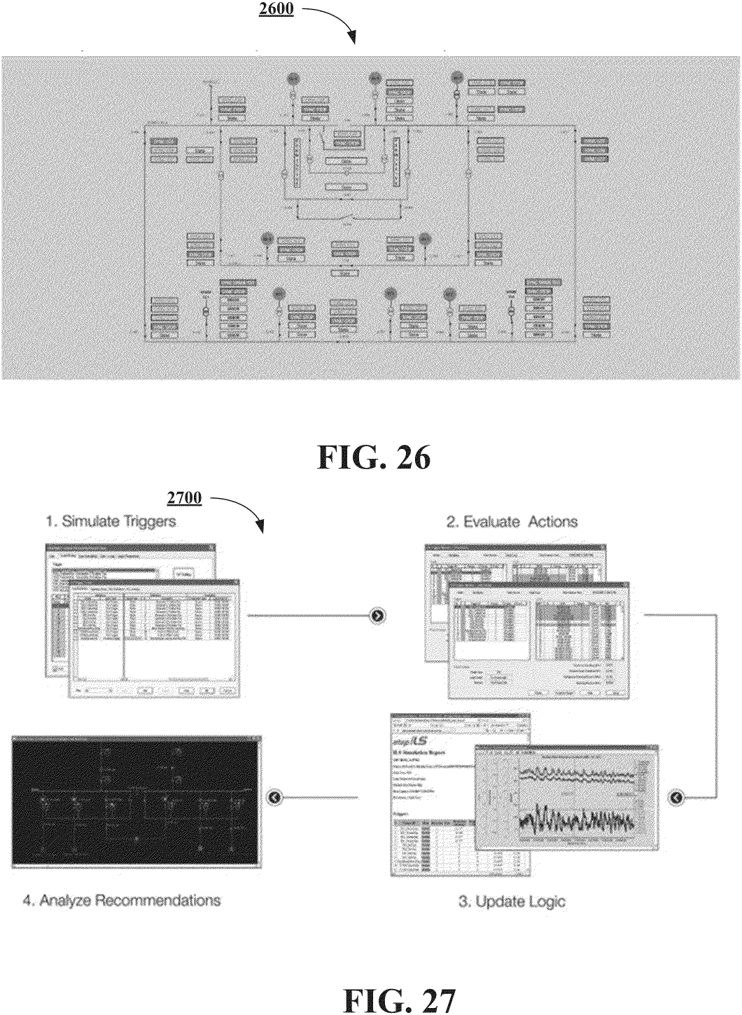

FIG. 24 is a diagram of an example generator capability curve 2400 in accordance with the systems and methods described herein. FIG. 25 is a diagram illustrating generator control 2500 in accordance with the systems and methods described herein. FIG. 26 is a diagram of an example of generator synchronization 2600 in accordance with the systems and methods described herein. These aspects of the systems and methods described herein are described in more detail below.

In an example embodiment, automatic generation control software is fully integrated with Economic Dispatch and Interchange Scheduling, automatically ensuring that generation adjustments are scheduled in the most economical fashion. AGC also calculates the parameters required for load frequency control and provides the required data on demand to maintain system frequency and power interchanges with neighboring systems at scheduled values.

In an example embodiment, ETAP allows you to monitor, analyze, control, coordinate, and predict load/generation demands, real-time costs, and other system parameters while maintaining proper reliability levels throughout the system.

In an example embodiment, generator Synchronization can also be performed and checked for system with different sub-islands.

### Load Shedding Simulation and Validation

In an example embodiment, with the simulator, Intelligent Load Shedding recommendations can be tested and analyzed before taking the system online. Steady-state and transient conditions can be simulated to analyze the load shedding system response. Some examples may include one or more of:

FIG. 27 is a diagram illustrating a process flow 2700 including simulating triggers, evaluating actions, analyzing recommendations, and updating logic in accordance with the systems and methods described herein. These aspects of the systems and methods described herein are described in more detail below.

Load Shedding Validation Features may include one or more of the following: (1) Confirm Load Shedding Actions, (2) Integrated Stability Knowledge Base, (3) Simulate Intelligent Load Shedding Recommendations, (4) Automatic Generation of Transient Study Cases, (5) Simulate Conditions and Triggers, (6) Loss of generation, (7) Under-frequency, (8) Mechanical failures, (9) Steam pressure decay, and (10) Other conditions leading to load shed

### Smart Dynamic Simulator

In an example embodiment, the ILS simulator utilizes both simulated and real-time operating data. It is the perfect tool for predicting the system response and load shedding actions for “what-if” scenarios or upon modifications to the existing load shedding schemes, load additions, and interlock modifications.

### Event Playback

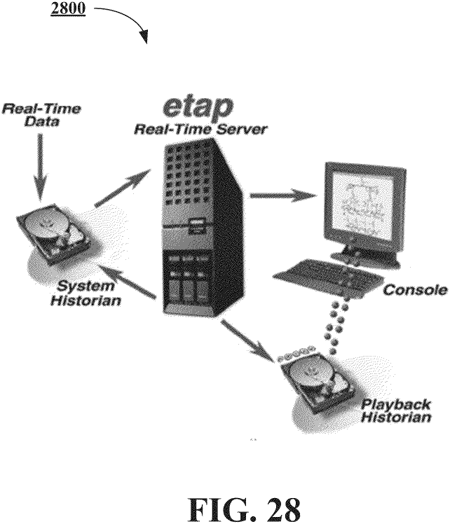

FIG. 28 is a diagram illustrating an example server system 2800 in accordance with the systems and methods described herein. These aspects of the systems and methods described herein are described in more detail below.

In an example embodiment, may include ETAP SCADA and PMS has the capability of utilizing simulated, Real Time, and Historical (Playback Data) for the purpose of simulating operations and analysis of the systems.

The software implemented in this system may be the same version as used by the ETAP SCADA and PMS system. The system may be setup, so it runs in two modes: standalone mode and interconnected mode. Standalone mode may be used: (1) to utilize simulated for training purposes and/or (2) to develop test and validate for newly added substations. Interconnected mode may be used: (1) to utilize simulated for training purposes, (2) to utilize Real-Time and\or Historical Data, and/or (3) to develop test and validate for newly added substations.

Event Playback may be especially useful for root cause and effect investigations, improvement of system operations, exploration of alternative actions, and replay of What If scenarios. ETAP Event Playback capabilities may translate into reduction of maintenance costs and prevention of costly shutdowns. ETAP can be configured to provide a complete picture of the electrical system from the stored data. This may include playback of a previously recorded monitored data, calculated system parameters, sequence of events, and message log.

In an example embodiment, additionally, the event log can be synchronized and displayed while the playback is in progress. This may allow the operator to determine, at a specific time, what events were occurring in the power system, what was being reported to the operator, and what operator action resulted, if any.

In an example embodiment, the Event Playback mode provides seamless retrieval of data from the ETAP historian for any events from any ETAP console. The playback data may be stored in an ODBC/SQL database and can be transferred to any user with the appropriate authorization.

In an example embodiment, the system operator can control playbacks to re-run at original or accelerated speeds, single-step, fast-forward, or rewind through the message log. Playback resolution is operator controlled and determined by the scan rate of field devices. Since full simulation capabilities are available to the system operator at any point during the replay, the operator can explore the effects of alternative actions at any point of recorded data.

In an example embodiment, event Playback may be especially useful for root cause and effect investigations, improvement of system operations, exploration of alternative actions, and replay of What If scenarios. ETAP Event Playback capabilities translate into reduction of maintenance costs and prevention of costly shutdowns. ETAP can be configured to provide a complete picture of the electrical system from the stored data. This includes playback of a previously recorded monitored data, calculated system parameters, sequence of events, and message log.

In an example embodiment, additionally, the event log can be synchronized and displayed while the playback is in progress. This allows the operator to determine, at a specific time, what events were occurring in the power system, what was being reported to the operator, and what operator action resulted, if any.

In an example embodiment, the Event Playback mode provides seamless retrieval of data from the ETAP historian for any events from any ETAP console. The playback data is stored in an ODBC/SQL database and can be transferred to any user with the appropriate authorization.

In an example embodiment, the system operator can control playbacks to re-run at original or accelerated speeds, single-step, fast-forward, or rewind through the message log. Playback resolution is operator controlled and determined by the scan rate of field devices. Since full simulation capabilities are available to the system operator at any point during the replay, the operator can explore the effects of alternative actions at any point of recorded data.

Incorporated is an Appendix (attached), which forms part of this disclosure.

The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system’s registers and memories into other data similarly represented as physical quantities within the computer system’s memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/ flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for power system simulation, the system comprising:
a processor; and
a memory, coupled to the processor, the memory including instructions that, when executed by the processor cause the system to:
generate dynamic graphical simulation of a power system,
receive an input from the user of the power system simulation,
generate a realistic response to the input from the user, and
provide the response to the user.

2. The system of claim 1, where in the dynamic graphical simulation of the power system is generated using at least one of simulated data, real-time data, and historical data.

3. The system of claim 2, wherein historical data comprises playback data.

4. The system of claim 1, wherein the system is configured to run in a standalone mode.

5. The system of claim 4, wherein the standalone mode is utilized to perform simulations for training purposes.

6. The system of claim 4, wherein the standalone mode is utilized to develop test and validate for a newly added element or network.

7. The system of claim 1, wherein the system is configured to run in an interconnected mode.

8. The system of claim 7, wherein the interconnected mode is utilized to perform simulations for training purposes.

9. The system of claim 7, wherein the interconnected mode is utilized to develop test and validate for a newly added element or network.

10. The system of claim 7, wherein the interconnected mode is configured to utilize at least one of real-time and historical data.

11. The system of claim 1, wherein the system is configured to simulate performing switching of electrical system.

12. The system of claim 1, wherein the system is configured to simulate starting and/or stopping of large HV/MV motors and the system is further configured to provide outputs that allow a user to observe the impact of starting and/or stopping of large HV/MV motors on the network.

13. The system of claim 1, wherein the system is configured to simulate circuit breaker operation.

14. The system of claim 1, wherein the system is configured to identify potential operating problem with auto generated alarms and/or events.

15. The system of claim 1, wherein the system is configured to predict system response based on operator actions.
